(19) United States
(12) Patent Application Publication
(10) Pub. No.: US 2015/0066873 A1
(43) Pub. Date: Mar. 5, 2015

(54) POLICY BASED DEDUPLICATION TECHNIQUES

(71) Applicants: Kaladhar Voruganti, Sunnyvale, CA (US); Mike Wilson, Sunnyvale, CA (US); Barry Benight, Sunnyvale, CA (US)

(72) Inventors: Kaladhar Voruganti, Sunnyvale, CA (US); Mike Wilson, Sunnyvale, CA (US); Barry Benight, Sunnyvale, CA (US)

(21) Appl. No.: 14/014,789

(22) Filed: Aug. 30, 2013

(51) Int. Cl. G06F 17/30

(52) U.S. Cl. CPC G06F 17/30489
USPC 707/692

(57) ABSTRACT

Policy based deduplication techniques are described. A deduplication application may manage deduplication operations for a storage system. The deduplication application may comprise, among other elements, a deduplication handler component to receive a deduplication request to perform deduplication operations for a logical container of a storage system. The deduplication application may further comprise a policy manager component to retrieve a data compliance policy associated with the logical container, the data compliance policy to comprise a set of rules to control deduplication operations for the logical container. The deduplication application may still further comprise a deduplication manager component to determine whether to perform deduplication operations for the logical container based on the data compliance policy for the logical container. Other embodiments are described and claimed.

### BACKGROUND

Data deduplication is a technique for removing duplicate copies of data. This technique may be used to improve storage utilization. In data deduplication, unique chunks of data are identified and stored. When a matching chunk of data is found, the redundant chunk is replaced with a small reference that points to the stored chunk. Given the frequency of matching chunks of data in a massive network storage facility, the amount of data needed to be stored may be greatly reduced. As such, improvements to data deduplication techniques may provide significant technical advantages.

### SUMMARY

The following presents a simplified summary in order to provide a basic understanding of some novel embodiments described herein. This summary is not an extensive overview, and it is not intended to identify key/critical elements or to delineate the scope thereof. Its sole purpose is to present some concepts in a simplified form as a prelude to the more detailed description that is presented later.

Embodiments are generally directed to enhanced data deduplication techniques. In one embodiment, a deduplication application may manage deduplication operations for a storage system. The deduplication application may comprise, among other elements, a deduplication handler component to receive a deduplication request to perform deduplication operations for a logical container of a storage system. The deduplication application may further comprise a policy manager component to retrieve a data compliance policy associated with the logical container, the data compliance policy to comprise a set of rules to control deduplication operations for the logical container. The deduplication application may still further comprise a deduplication manager component to determine whether to perform deduplication operations for the logical container based on the data compliance policy for the logical container. Other embodiments are described and claimed.

To the accomplishment of the foregoing and related ends, certain illustrative aspects are described herein in connection with the following description and the annexed drawings. These aspects are indicative of the various ways in which the principles disclosed herein can be practiced and all aspects and equivalents thereof are intended to be within the scope of the claimed subject matter. Other advantages and novel features will become apparent from the following detailed description when considered in conjunction with the drawings.

### BRIEF DESCRIPTION OF THE DRAWINGS

FIG. 1 illustrates an embodiment of an apparatus.

FIG. 2 illustrates an embodiment of a first operating environment for the apparatus.

FIG. 3 illustrates an embodiment of a second operating environment for the apparatus.

FIG. 4 illustrates an embodiment of a third operating environment for the apparatus.

FIG. 5 illustrates an embodiment of a fourth operating environment for the apparatus.

FIG. 6 illustrates an embodiment of a fifth operating environment for the apparatus.

FIG. 7 illustrates an embodiment of a sixth operating environment for the apparatus.

FIG. 8 illustrates an embodiment of a centralized system for the apparatus.

FIG. 9 illustrates an embodiment of a distributed system for the apparatus.

FIG. 10 illustrates an embodiment of a storage network.

FIG. 11 illustrates an embodiment of a first logic flow.

FIG. 12 illustrates an embodiment of a second logic flow.

FIG. 13 illustrates an embodiment of a third logic flow.

FIG. 14 illustrates an embodiment of a storage medium.

FIG. 15 illustrates an embodiment of a computing architecture.

FIG. 16 illustrates an embodiment of a communications architecture.

### DETAILED DESCRIPTION

Various embodiments are generally directed to enhanced data deduplication techniques. Some embodiments are particularly directed to policy controlled data deduplication techniques. In one embodiment, for example, policy controlled data deduplication techniques may be implemented for a storage network, such as a storage area network (SAN) or a network attached storage (NAS) environment.

Policy controlled data deduplication techniques may control data deduplication on a policy level. A policy may comprise a set of rules designed to control use of a set of data, where the rules are interpretable by a machine. The rules may represent restrictions or constraints on use of the set of data. The restrictions may be based on legal rights, administrative rights, technical constraints, data source, data age, and any other type of rights or restrictions typically associated with a set of data. Data deduplication may then be performed for each set of data in view of its associated policy to ensure proper compliance with the policy. As a result, policy controlled data deduplication techniques may allow a storage network or storage device to take advantage of data deduplication to reduce storage requirements, while providing a refined level of control demanded by a complex set of restrictions that are often subject to change. This can improve affordability, scalability, modularity, extendibility, or interoperability for an operator, device or network.

With general reference to notations and nomenclature used herein, the detailed descriptions which follow may be presented in terms of program procedures executed on a computer or network of computers. These procedural descriptions and representations are used by those skilled in the art to most effectively convey the substance of their work to others skilled in the art.

A procedure is here, and generally, conceived to be a self-consistent sequence of operations leading to a desired result. These operations are those requiring physical manipulations of physical quantities. Usually, though not necessarily, these quantities take the form of electrical, magnetic or optical signals capable of being stored, transferred, combined, compared, and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to those quantities.

Further, the manipulations performed are often referred to in terms, such as adding or comparing, which are commonly associated with mental operations performed by a human operator. No such capability of a human operator is necessary, or desirable in most cases, in any of the operations described herein which form part of one or more embodiments. Rather, the operations are machine operations. Useful machines for performing operations of various embodiments include general purpose digital computers or similar devices.

Various embodiments also relate to apparatus or systems for performing these operations. This apparatus may be specially constructed for the required purpose or it may comprise a general purpose computer as selectively activated or reconfigured by a computer program stored in the computer. The procedures presented herein are not inherently related to a particular computer or other apparatus. Various general purpose machines may be used with programs written in accordance with the teachings herein, or it may prove convenient to construct more specialized apparatus to perform the required method steps. The required structure for a variety of these machines will appear from the description given.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modifications, equivalents, and alternatives consistent with the claimed subject matter.

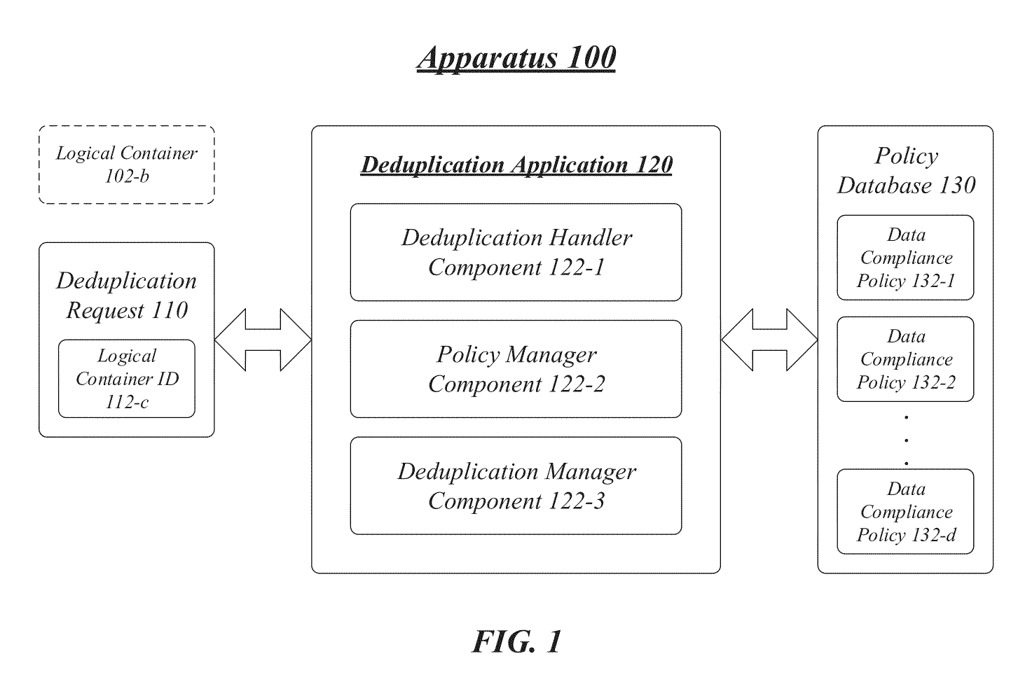

FIG. 1 illustrates a block diagram for an apparatus 100. In one embodiment, the apparatus 100 may comprise a computer-implemented apparatus 100 having a software application 120 comprising one or more components 122-a. Although the apparatus 100 shown in FIG. 1 has a limited number of elements in a certain topology, it may be appreciated that the apparatus 100 may include more or less elements in alternate topologies as desired for a given implementation.

It is worthy to note that “a” and “b” and “c” and similar designators as used herein are intended to be variables representing any positive integer. Thus, for example, if an implementation sets a value for a=5, then a complete set of components 122-a may include components 122-1, 122-2, 122-3, 122-4 and 122-5. The embodiments are not limited in this context.

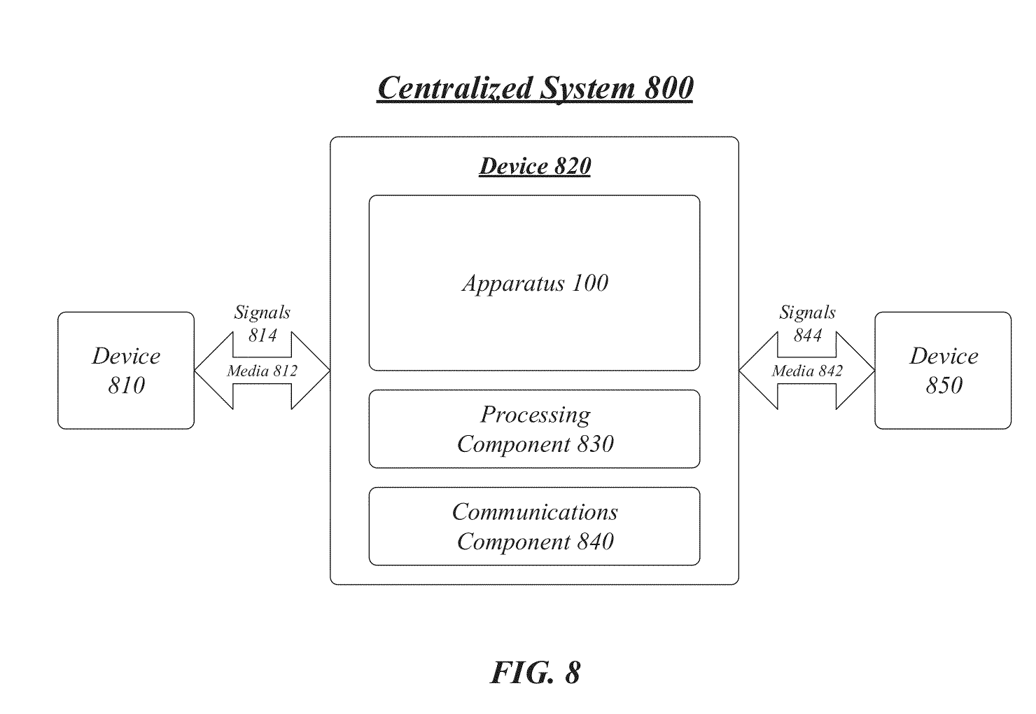

The apparatus 100 may comprise a deduplication application 120. The deduplication application 120 may be implemented using any number of programming languages or software frameworks. The deduplication application 120 may be generally arranged to manage data deduplication operations for a storage network or system, such as a NAS or SAN. The apparatus 100 in general, and the deduplication application 120 in particular, may be suitable for implementation by an electronic device, such as those described with reference to FIG. 8-10, 15 or 16, among others.

In one embodiment, the deduplication application 120 may comprise a deduplication handler component 122-1, a policy manager component 122-2, and a deduplication manager component 122-3. The deduplication application 120 may comprise more or less components as needed for a given implementation. Embodiments are not limited in this context.

The deduplication handler component 122-1 may be generally arranged to handle and route various deduplication requests 110. A deduplication request 110 may comprise a request to perform deduplication operations for a logical container 102-b of a storage system. The request may originate from a client, management server or storage server. The deduplication handler component 122-1 may process the deduplication request 110, and place a work item in a queue for the policy manager component 122-2.

A logical container 102-b may comprise any defined set of data, such as a file, object or block. The logical container 102 may be of any defined size depending on a type of storage technology and storage environment used to store the logical container 102. In one embodiment, the logical container 102 may be stored in some form of persistent storage, such as a nonvolatile mass storage device of a SAN or NAS environment. In this sense, the logical container 102 may sometimes be referred to as “data at rest.” Data at rest is defined as data that is stored in a persistent data storage facility, as opposed to data that is traversing a network or temporarily residing in computer memory to be read or updated. Data at rest can include archival files or reference files that are rarely if ever changed. Data at rest can also include data that is subject to regular, but not constant, change. Data at rest can include, for example vital corporate data stored on the hard drive of an employee's notebook computer, data on an external backup medium, data maintained in storage of a storage server on a SAN or NAS environment, or data on a server of an offsite backup service provider.

The policy manager component 122-2 may manage one or more deduplication policies 132-d associated with one or more logical containers 102. A policy database 130 may store a set of deduplication policies 132 corresponding to a set of logical containers 102. A data compliance policy 132 may comprise a set of rules to control deduplication operations for the logical container 102. The set of rules are interpretable by a machine, such as a storage server. The rules may represent restrictions or constraints on use of the logical containers 102 based on such factors as legal rights (e.g., digital rights, copyrights, distribution rights, etc.), administrative rights (e.g., user permissions, user account limitations, etc.), technical constraints (e.g., bandwidth constraints, network constraints, device constraints, etc.), data source, distribution channels, age of a logical container, and any other type of rights or restrictions typically associated with a set of data. These rules could be implemented in a number of different ways, including as a program in a standard or domain specific language, a set of declarations, and so forth.

The deduplication manager component 122-3 may manage data deduplication operations for a logical container 102. The deduplication manager component 122-3 may determine whether to perform deduplication operations for the logical container 102 based on the data compliance policy 132 for the logical container 102. Furthermore, the deduplication manager component 122-3 may determine how to perform deduplication operations for the logical container 102 based on the data compliance policy 132 for the logical container 102.

In general operation, the deduplication handler component 122-1 may receive a deduplication request 110 to perform deduplication operations for a logical container 102 of a storage system. The deduplication request 110 may include a logical container identifier (ID) 112-c to identify the logical container 102. The policy manager component 122-2 may retrieve a data compliance policy 132 associated with the logical container 102 based on the logical container identifier 112. The deduplication manager component 122-3 may determine whether to perform deduplication operations for the logical container 102 based on the data compliance policy 132 for the logical container 102. The deduplication manager component 122-3 may then request or perform data deduplication operations for the logical container 102 based on this determination.

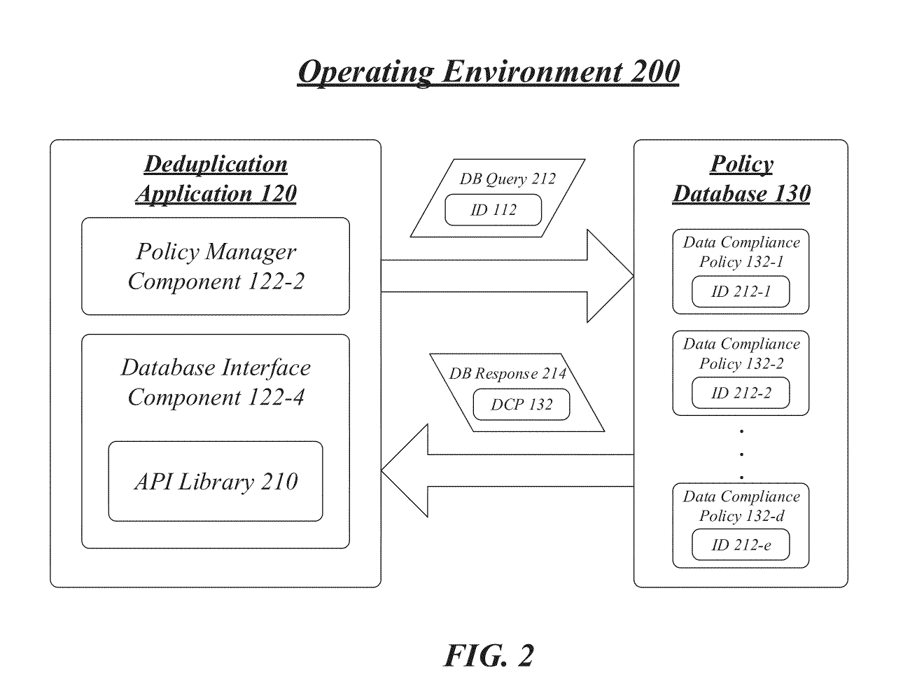

FIG. 2 illustrates an embodiment of an operational environment 200 for the apparatus 100. The operational environment 200 illustrates exemplary interactions between the deduplication application 120 and the policy database 130.

As shown in FIG. 2, the deduplication application 120 may include a database interface component 122-4. The database interface component 122-4 may include an application program interface (API) library 210. The API library 210 may comprise a set of APIs that allows the policy manager component 122-2 to communicate with the policy database 130. The policy database 130 may be implemented using any suitable database technology, such as a relational database management system (RDMS), for example. The API library 210 may be selected for compatibility with a given database technology.

When the deduplication handler component 122-1 receives a deduplication request 110 to perform deduplication operations for a logical container 102 of a storage system, the deduplication handler component 122-1 may retrieve a logical container ID 112 from the deduplication request 110, and store a work item in a queue for the policy manager component 122-2. The deduplication handler component 122-1 may notify the policy manager component 122-2 of the new work item, or alternatively, the policy manager component 122-2 may monitor a work queue for presence of any new work items. The monitoring may be on a periodic, aperiodic, continuous or on-demand basis.

The policy manager component 122-2 may detect a new work item, and retrieve a data compliance policy 132 associated with the logical container 102 from the policy database 130. The policy manager component 122-2 may retrieve a logical container ID 112 from the work item to identify the logical container 102. The policy manager component 122-2 may generate and send a database (DB) query 212 to the policy database 130 via the database interface component 122-4. The DB query 212 may be constructed in a language suitable for the policy database 130, such as sequel query for a RDMS, for example.

The DB query 212 may comprise a request to search for a data compliance policy 132 having a logical container ID 212-e that matches the logical container ID 112 stored in the policy database 130. The policy database 130 may perform the search, and when a match is found, the policy database 130 may send a DB response 214 with the data compliance policy 132 corresponding to the logical container ID 112 (212) to the deduplication application 120.

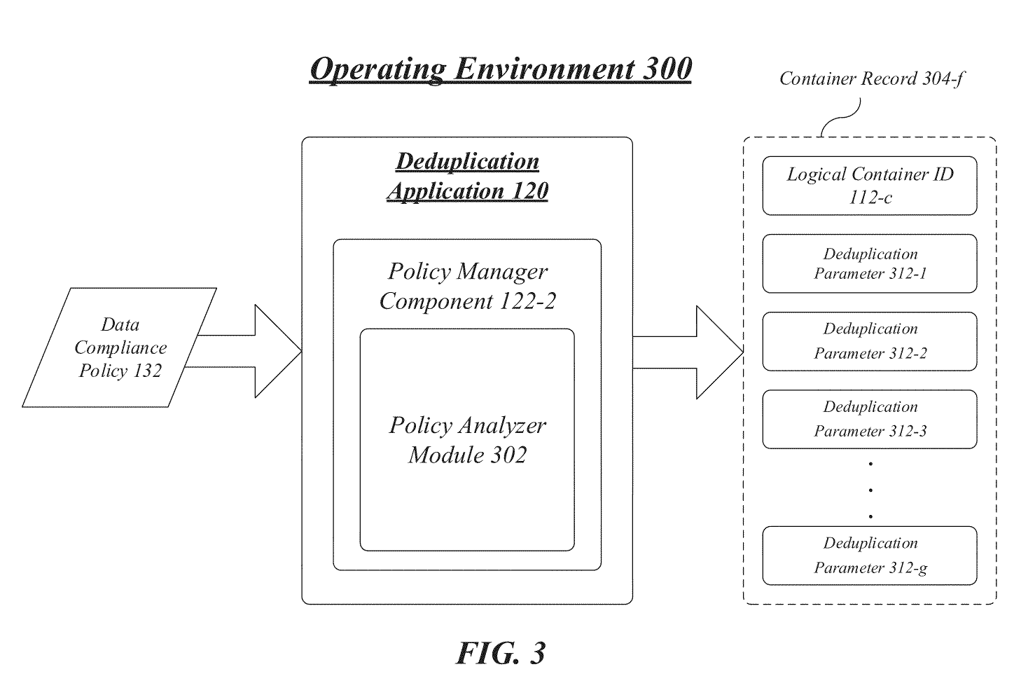

FIG. 3 illustrates an embodiment of an operational environment 300 for the apparatus 100. The operational environment 300 illustrates exemplary operations of a policy manager component 122-2 of the deduplication application 120.

As shown in FIG. 3, the policy manager component 122-2 may comprise a policy analyzer module 302. The policy analyzer module 302 may receive as input a data compliance policy 132 received with the DB response 214, and analyze the data compliance policy 132 to generate a set of deduplication parameters 312-g for the logical container 102. As previously described, the data compliance policy 132 may comprise a set of rules representing various restrictions or constraints on use of the logical container 102, which may be used to control deduplication operations for the logical container 102. The set of rules may be implemented in a number of different ways, including as a program in a standard or domain specific language, a set of declarations, and so forth.

In one embodiment, the policy analyzer module 302 may process the rules and generate a set of deduplication parameters 312 for the logical container 102. A deduplication parameter 312 may represent a command, data, a logical operation for the command or data, a condition or variable that may be used to control deduplication operations. For instance, a rule may expressly authorize or deny deduplication operations for the logical container 102. A first deduplication parameter 312-1 may comprise a deduplication authorized parameter to authorize deduplication operations for the logical container 102. A second deduplication parameter 312-2 may comprise a deduplication denied parameter to deny deduplication operations for the logical container 102.

In one embodiment, a rule may conditionally authorize or deny deduplication operations for a logical container 102. For instance, a rule may be constructed to indicate that deduplication operations are only allowed for the logical container 102 when provided from a particular data source, such as a video distribution provider. In this example, the policy analyzer module 302 may generate and store a third deduplication parameter 312-3 with an identifier for the video distribution provider. Another rule may indicate that deduplication operations are only allowed for the logical container after a certain time period. The policy analyzer module 302 may generate and store a fourth deduplication parameter 312-4 with a defined time interval (e.g., 30 days). The policy analyzer module 302 may process each of the rules in the data compliance policy 132 to generate one or more corresponding deduplication parameters 312. The data compliance policy 132 may be processed once, or multiple times, depending on a given implementation.

Alternatively, the data compliance policy 132 may comprise a previously generated set of deduplication parameters 312. In this implementation, the policy analyzer module 302 may be omitted and the policy manager component 122-2 may simply retrieve the deduplication parameters 312 from the data compliance policy 132.

Once the set of deduplication parameters 312 are generated or retrieved, the policy manager component 122-2 may send the deduplication parameters 312 to the policy database 130. The policy database 130 may create a container record 304-f for the logical container 102. The container record 304 may comprise, for example, a logical container ID 212 matching the logical container ID 112 of the logical container 102, along with the set of deduplication parameters 312 associated with the logical container 102.

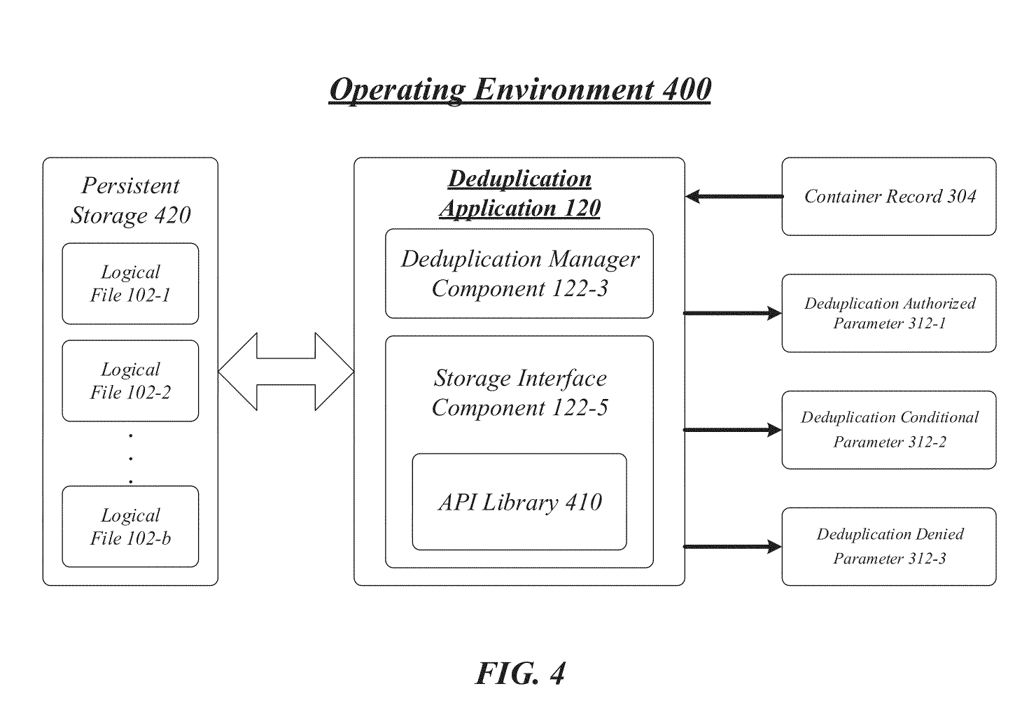

FIG. 4 illustrates an embodiment of an operational environment 400 for the apparatus 100. The operational environment 400 illustrates exemplary operations of a deduplication manager component 122-3 of the deduplication application 120.

As shown in FIG. 4, the deduplication application 120 may comprise a storage interface component 122-5. The storage interface component 122-5 may include an API library 410. The API library 410 may comprise a set of APIs that allows the deduplication manager component 122-3 to communicate with persistent storage 420. The persistent storage 420 may be implemented using any suitable storage technology, such as non-volatile mass storage device of a SAN or NAS environment, for example. The API library 410 may be selected for compatibility with a given storage technology.

The deduplication manager component 122-3 may determine whether to perform deduplication operations for the logical container 102 based on the data compliance policy 132 for the logical container 102. Prior to performing deduplication operations, the deduplication manager component 122-3 may retrieve a container record 304 having a logical container ID 212 and a set of one or more deduplication parameters 312 for the logical container 102. The deduplication manager component 122-3 may evaluate each set of deduplication parameters 312, and generate a deduplication status for the logical container 102 based on results of the evaluation. The evaluation may include processing any express deduplication commands, such as in the case of a deduplication authorized parameter or a deduplication denied parameter. The evaluation may also include processing any conditional deduplication commands, such as ensuring that a set of conditions are met before granting deduplication operations. In one embodiment, for example, a deduplication status may comprise a permission granted status, a permission conditional status, or a permission denied status. It may be appreciated, however, that embodiments are not limited to these examples.

In one embodiment, the deduplication manager component 122-3 may evaluate a set of deduplication parameters 312 for the logical container 102, and generate a permission granted status to authorize deduplication operations for the logical container 102. The permission granted status indicates that deduplication operations are authorized for the logical container 102 regardless of any other conditions for that particular logical container 102.

In one embodiment, the deduplication manager component 122-3 may evaluate a set of deduplication parameters 312 for the logical container 102, and generate a permission denied status to deny deduplication operations for the logical container 102. The permission denied status indicates that deduplication operations are denied for the logical container 102 regardless of any other conditions for that particular logical container 102.

In one embodiment, the deduplication manager component 122-3 may evaluate a set of deduplication parameters 312 for the logical container 102, and generate a permission conditional status to authorize deduplication operations for the logical container 102 when one or more conditions are met. The permission conditional status indicates that deduplication operations are authorized for the logical container 102 when the conditions (e.g., age, data source, storage device, etc.) are met for that particular logical container 102.

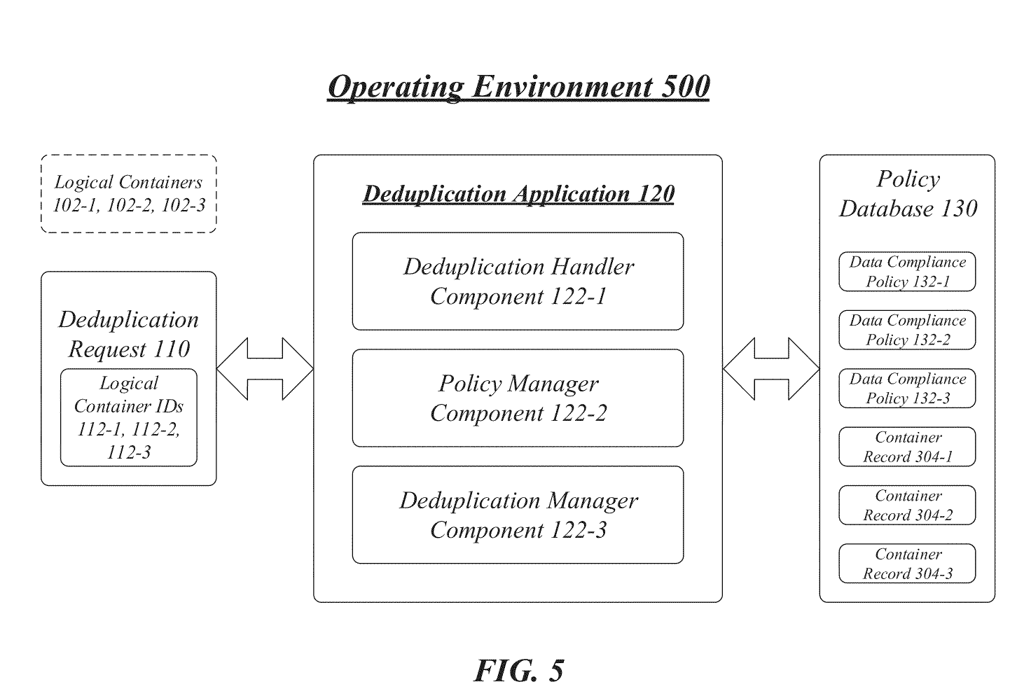

In the case of a permission granted status or permission conditional status where the conditions are met, the deduplication manager component 122-3 may perform deduplication operations for the logical container 102 based on the deduplication parameters 312 for a logical container 102. For instance, the deduplication manager component 122-3 may interact with the persistent storage 420 via the storage interface component 122-5 and the API library 410 to retrieve logical container 102-1, and perform deduplication operations with another logical container 102-2 . . . 102-b based on a deduplication status set for the other logical container 102-2 . . . 102-b, as described in more detail with reference to FIGS. 5-8. Alternatively, the deduplication manager component 122-3 may authorize another device (e.g., another storage server or a network appliance) to perform deduplication operations for the logical container 102.

While FIGS. 2-4 describe policy controlled deduplication techniques with respect to a single logical container 102 for purposes of clarity, in many cases actual implementation of the policy controlled deduplication techniques will be made with respect to multiple logical containers 102 within a set of logical containers. In such cases, the deduplication manager component 122-3 may need to evaluate deduplication parameters 312 for each of the logical containers 102 prior to setting a deduplication status for the set of containers.

FIG. 5 illustrates an embodiment of an operational environment 500 for the apparatus 100. The operational environment 500 illustrates exemplary operations of a deduplication manager component 122-3 of the deduplication application 120 when evaluating deduplication parameters 312 for multiple logical containers 102.

As shown in FIG. 5, the deduplication application 120 may manage deduplication operations for a storage system, such as a SAN or NAS. The deduplication application 120 may include the deduplication handler component 122-1 arranged to receive a deduplication request 110 to perform deduplication operations for a set of logical containers 102-1, 102-2 and 102-3 of the storage system. The deduplication request 110 may include logical container IDs 112-1, 112-2 and 112-3 corresponding to the logical containers 102-1, 102-2 and 102-3, respectively.

The policy manager component 122-2 may be arranged to retrieve a set of data compliance policies 132-1, 132-2 and 132-3 each corresponding to one of the logical containers 102-1, 102-2 or 102-3, respectively, utilizing the logical container IDs 112-1, 112-2 and 112-3, respectively. The policy analyzer module 302 of the policy manager component 122-2 may analyze the data compliance policies 132-1, 132-2 and 132-3, and generate a set of deduplication parameters 312-1, 312-2 and 312-3 each corresponding to one of the logical containers 102-1, 102-2 or 102-3, respectively. Alternatively, the policy manager component 122-2 may be arranged to retrieve a set of previously generated and stored deduplication parameters 312-1, 312-2 and 312-3 each corresponding to one of the logical containers 102-1, 102-2 or 102-3, respectively, utilizing the logical container IDs 112-1, 112-2 and 112-3, respectively.

The deduplication manager component 122-3 may determine whether each deduplication parameter 312-1, 312-2 and 312-3 grants permission to perform deduplication operations for the logical containers 102-1, 102-2 and 102-3, respectively.

When each deduplication parameter 312-1, 312-2 and 312-3 for the set of logical containers 102-1, 102-2 and 102-3, respectively, grants permission to perform deduplication operations, the deduplication manager component 122-3 may authorize deduplication operations for the set of logical containers 102-1, 102-2 and 102-3. The deduplication manager component 122-3 may then perform deduplication operations for the logical containers 102-1, 102-2 and 102-3.

However, when a deduplication parameter 312-1, 312-2 and 312-3 for one of the logical containers 102-1, 102-2 and 102-3 in the set of logical containers denies permission to perform deduplication operations, the deduplication manager component 122-3 may deny deduplication operations for the entire set of logical containers 102-1, 102-2 and 102-3. This may occur even if a particular logical container that denies permission to perform deduplication operations has a lower priority than the other logical containers that permit deduplication operations.

In this case, the deduplication manager component 122-3 may remove any logical containers from the set of logical containers when a deduplication parameter for the removed logical containers deny permission to perform deduplication operations, and authorize deduplication operations for any remaining logical containers in the set of logical containers when each deduplication parameter for the remaining set of logical containers grants permission to perform deduplication operations. For instance, assume a deduplication parameter for the logical container 102-2 denies permission to perform deduplication operations. The deduplication manager component 122-3 may remove the logical container 102-2 from the set of logical containers 102-1, 102-2 and 102-3, and authorize deduplication operations for the remaining logical containers 102-1, 102-3 in the set of logical containers 102-1, 102-2 and 102-3 when each deduplication parameter for the remaining set of logical containers 102-1, 102-3 grants permission to perform deduplication operations. The deduplication manager component 122-3 may perform deduplication operations for the remaining logical containers 102-1, 102-3.

When each deduplication parameter 312-1, 312-2 and 312-3 for the set of logical containers 102-1, 102-2 and 102-3, respectively, grants permission to perform deduplication operations, the deduplication manager component 122-3 may authorize deduplication operations for the set of logical containers 102-1, 102-2 and 102-3. The deduplication manager component 122-3 may then perform deduplication operations for the logical containers 102-1, 102-2 and 102-3. However, if one of the deduplication parameter 312-1, 312-2 and 312-3 for the set of logical containers 102-1, 102-2 and 102-3, respectively, is modified to deny deduplication operations, or if a new logical container 102-4 is added to the set of logical containers with a deduplication parameter 312-4 that denies deduplication operations, then deduplication operations will cease. The deduplication manager component 122-3 may periodically perform background scans on the set of logical containers and corresponding deduplication parameters to ensure deduplication operations are still permitted, and if not, send control directives to cease deduplication operations.

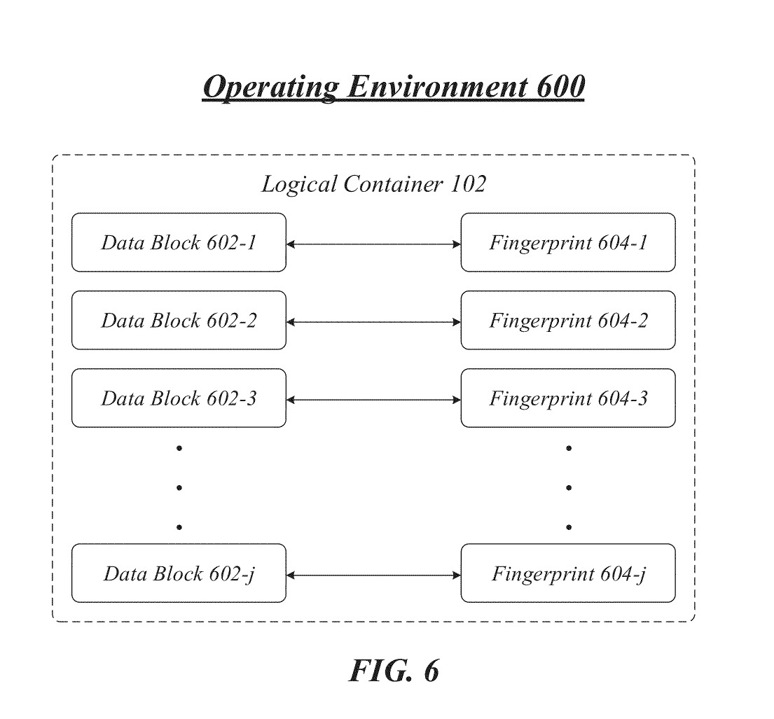

FIG. 6 illustrates an embodiment of an operational environment 600 for the apparatus 100. The operational environment 600 illustrates exemplary operations of a deduplication manager component 122-3 of the deduplication application 120 when performing deduplication operations for multiple logical containers 102.

Any number of data deduplication techniques may be used to actually perform deduplication operations for a set of logical containers 102, such as the logical containers 102-1, 102-2 and 102-3 as described with reference to FIG. 5. In one embodiment, each of the logical containers 102-1, 102-2 and 102-3 may comprise one or more data blocks 602-j. Each data block 602-j may have an associated fingerprint 604-j.

The deduplication manager component 122-3 may be arranged to identify duplicate data blocks 602 for the set of logical containers 102-1, 102-2 and 102-3 based on a fingerprint 604 for each of the data blocks 602. Data blocks 602 may be processed through a hash function or other similar function to generate a unique fingerprint 604 (e.g., value) for each data block 602. The fingerprint 604 is subsequently used to identify and coalesce duplicate data blocks 602. Fingerprints 604 can also be used for file signing as well as for conventional data integrity checks. The fingerprints 604 themselves may also be digitally signed to prevent or detect tampering. Fingerprinting logic and a fingerprint database (not shown) may be utilized to generate the fingerprints 604. The fingerprinting logic, such as hash logic, may be used to generate a fingerprint 604 for each data block 602 of a logical container 102. The data blocks 602 may be in a compressed or uncompressed state. The fingerprints 604 may be stored in the fingerprints database. In one embodiment, for example, SHA-256 or SHA-512 may be used to generate the fingerprints 604. Optionally, the fingerprints 604 may be digitally signed by a signature function. The fingerprint 604 (or signed fingerprint) is then stored in the fingerprint database for future use in deduplication operations. Embodiments are not limited in this context.

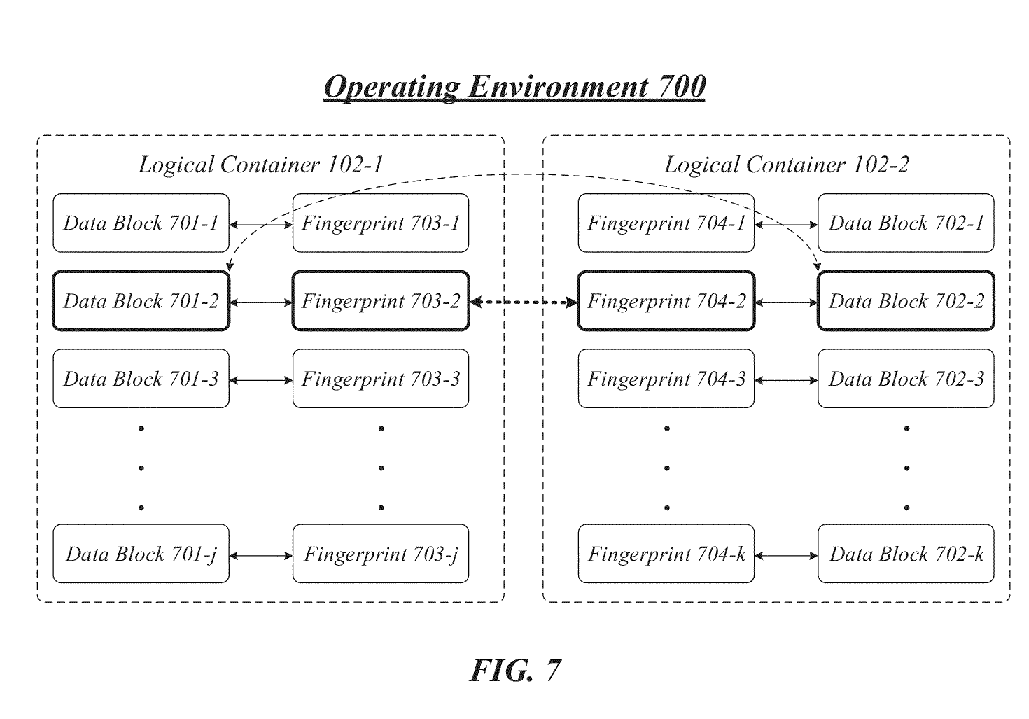

FIG. 7 illustrates an embodiment of an operational environment 700 for the apparatus 100. The operational environment 700 illustrates exemplary operations of a deduplication manager component 122-3 of the deduplication application 120 when performing deduplication operations for multiple logical containers 102.

As shown in FIG. 7, a logical container 102-1 may comprise data blocks 701-1, 701-2 and 701-3 each having a corresponding fingerprint 703-1, 703-2 and 703-3, respectively. Similarly, a logical container 102-2 may comprise data blocks 702-1, 702-2 and 702-3 each having a corresponding fingerprint 704-1, 704-2 and 704-3, respectively.

The deduplication manager component 122-3 may implement duplicate detection logic to detect duplicate data blocks based on fingerprints stored in a fingerprints database. For instance, assume the duplicate detection logic detects that fingerprints 703-2, 704-2 substantially match, indicating that the corresponding data blocks 701-2, 702-2 are duplicates. The deduplication manager component 122-3 eliminate duplicate data blocks 701-2, 702-2 by coalescing the duplicate data blocks 701-2, 702-2, such as by replacing one of the data blocks 701-2 with a reference to the other data block 702-2. The deduplication process may continue for other data blocks 701-j, 702-k as needed.

FIG. 8 illustrates a block diagram of a centralized system 800. The centralized system 800 may implement some or all of the structure and/or operations for the apparatus 100 in a single computing entity, such as entirely within a single device 820.

The device 820 may comprise any electronic device capable of receiving, processing, and sending information for the apparatus 100. Examples of an electronic device may include without limitation a computer, a server, a server array or server farm, a web server, a network server, an Internet server, a storage server, a work station, a mini-computer, a main frame computer, a supercomputer, a network appliance, a web appliance, a distributed computing system, multiprocessor systems, processor-based systems, a machine, or combination thereof. The embodiments are not limited in this context.

The device 820 may execute processing operations or logic for the apparatus 100 using a processing component 830. The processing component 830 may comprise various hardware elements, software elements, or a combination of both. Examples of hardware elements may include devices, logic devices, components, processors, microprocessors, circuits, processor circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

The device 820 may execute communications operations or logic for the apparatus 100 using communications component 840. The communications component 840 may implement any well-known communications techniques and protocols, such as techniques suitable for use with packet-switched networks (e.g., public networks such as the Internet, private networks such as an enterprise intranet, and so forth), circuit-switched networks (e.g., the public switched telephone network), or a combination of packet-switched networks and circuit-switched networks (with suitable gateways and translators). The communications component 840 may include various types of standard communication elements, such as one or more communications interfaces, network interfaces, network interface cards (NIC), radios, wireless transmitters/receivers (transceivers), wired and/or wireless communication media, physical connectors, and so forth. By way of example, and not limitation, communication media 812, 842 include wired communications media and wireless communications media. Examples of wired communications media may include a wire, cable, metal leads, printed circuit boards (PCB), backplanes, switch fabrics, semiconductor material, twisted-pair wire, co-axial cable, fiber optics, a propagated signal, and so forth. Examples of wireless communications media may include acoustic, radio-frequency (RF) spectrum, infrared and other wireless media.

The device 820 may communicate with other devices 810, 850 over a communications media 812, 842, respectively, using communications signals 814, 844, respectively, via the communications component 840. The devices 810, 850 may be internal or external to the device 820 as desired for a given implementation.

In one embodiment, the apparatus 100 in general, and the deduplication application 120 in particular, may be implemented as part of a storage server for nonvolatile mass storage facility, such as a SAN or NAS. The deduplication application 120 may be implemented for each storage server in the SAN or NAS, or may be a shared resource for multiple storage servers in the SAN or NAS. In the latter case, the deduplication application 120 may be part of a management server or network appliance. Embodiments are not limited in this context.

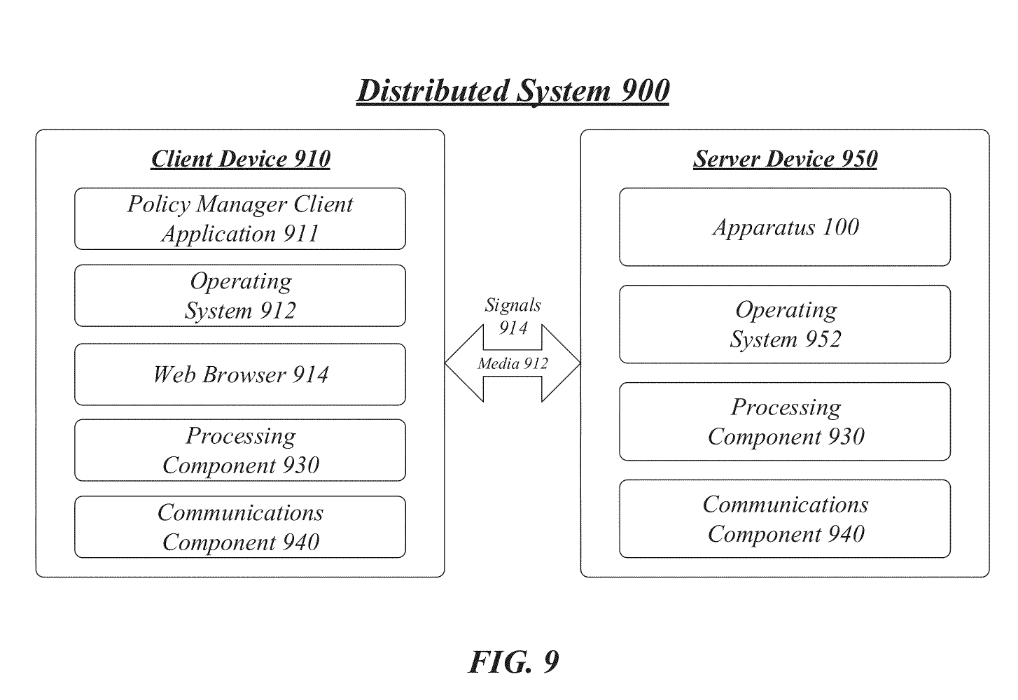

FIG. 9 illustrates a block diagram of a distributed system 900. The distributed system 900 may distribute portions of the structure and/or operations for the apparatus 100 across multiple computing entities. Examples of distributed system 900 may include without limitation a client-server architecture, a 3-tier architecture, an N-tier architecture, a tightly-coupled or clustered architecture, a peer-to-peer architecture, a master-slave architecture, a shared database architecture, and other types of distributed systems. The embodiments are not limited in this context.

The distributed system 900 may comprise a client device 910 and a server device 950. In general, the client device 910 and the server device 950 may be the same or similar to the client device 820 as described with reference to FIG. 8. For instance, the client system 910 and the server system 950 may each comprise a processing component 930 and a communications component 940 which are the same or similar to the processing component 830 and the communications component 840, respectively, as described with reference to FIG. 8. In another example, the devices 910, 950 may communicate over a communications media 912 using communications signals 914 via the communications components 940.

The server device 950 may comprise or employ one or more server programs that operate to perform various methodologies in accordance with the described embodiments. In one embodiment, for example, the server device 950 may implement the deduplication application 120. The deduplication application 120 may be considered a server program in that is services requests from the policy manager client application 911.

The client device 910 may comprise or employ one or more client programs that operate to perform various methodologies in accordance with the described embodiments. In one embodiment, for example, the client device 910 may implement a policy manager client application 911. The policy manager client application 911 may be considered a client program in that it requests services from the deduplication application 120. For instance, a user may utilize the policy manager client application 911 to upload and manage a data compliance policy 132 for logical containers 102 under its control.

Client device 910 may further comprise a web browser 914. The web browser 914 may be used in lieu of the policy manager client application 911 to access the server-based deduplication application 120. The web browser 914 may comprise any commercial web browser. The web browser 914 may be a conventional hypertext viewing application such as MICROSOFT INTERNET EXPLORER®, APPLE® SAFARI®, FIREFOX® MOZILLA®, GOOGLE® CHROME®, OPERA®, and other commercially available web browsers. Secure web browsing may be supplied with 128-bit (or greater) encryption by way of hypertext transfer protocol secure (HTTPS), secure sockets layer (SSL), transport security layer (TSL), and other security techniques. Web browser 914 may allow for the execution of program components through facilities such as ActiveX, AJAX, (D)HTML, FLASH, Java, JavaScript, web browser plug-in APIs (e.g., FireFox, Safari Plug-in, and the like APIs), and the like. The web browser 914 may communicate to and with other components in a component collection, including itself, and facilities of the like. Most frequently, the web browser 914 communicates with information servers (e.g., server devices 820, 850), operating systems, integrated program components (e.g., plug-ins), and the like. For example, the web browser 914 may contain, communicate, generate, obtain, and provide program component, system, user, and data communications, requests, and responses. Of course, in place of the web browser 914 and information server, a combined application may be developed to perform similar functions of both.

A human operator such as a network administrator may utilize the web browser 914 to access applications and services provided by the server device 950. For instance, the web browser 914 may be used to configure file recovery operations performed by the deduplication application 120 on the server device 950. The web browser 914 may also be used to access cloud-based applications and services, such as online storage applications, services and tools.

In addition to the policy manager client application 911, the client device 910 may be another device with a SAN or NAS. For instance, when the deduplication application 120 is a shared resource, the client device 910 may comprise another storage server within the SAN or NAS. Embodiments are not limited in this context.

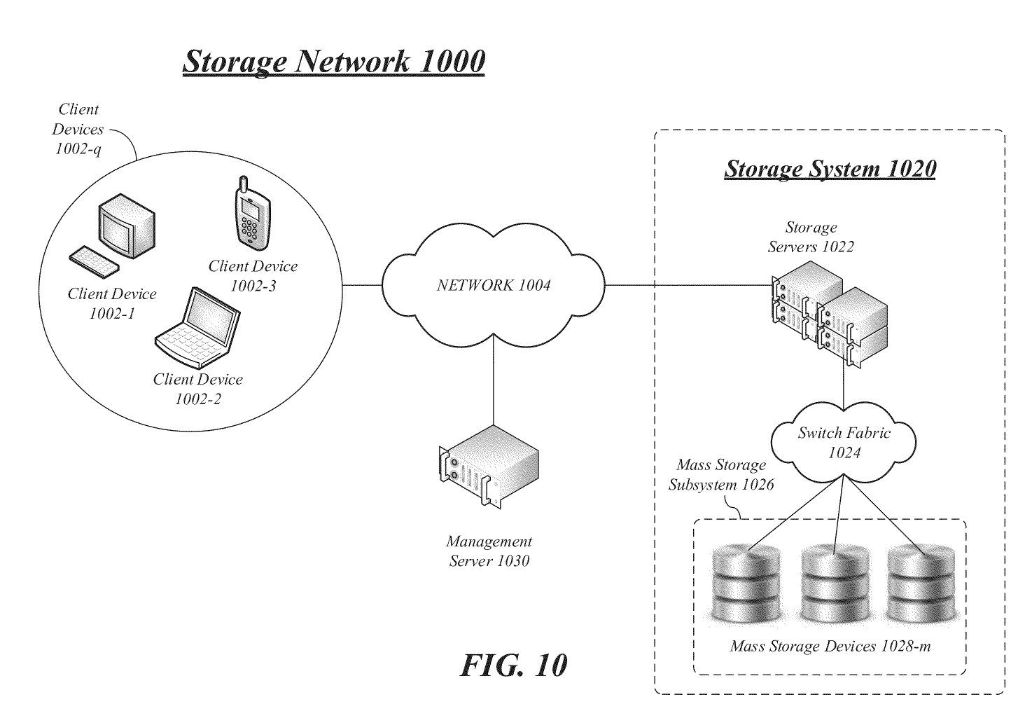

FIG. 10 illustrates an embodiment of a storage network 1000. The storage network 1200 provides a network level example of an environment suitable for use with the apparatus 100.

In the illustrated embodiment shown in FIG. 10, a set of client devices (or systems) 1002-q may comprise client devices 1002-1, 1002-2 and 1002-3. The client devices 1002-q may comprise representative examples of a class of devices a user may utilize to access online storage services. As shown in FIG. 10, each client device 1002-q may represent a different electronic device a user can utilize to access a web services and web applications provided by a network management server 1012. For instance, the client device 1002-1 may comprise a desktop computer, the client device 1002-2 may comprise a notebook computer, and the client device 1002-3 may comprise a smart phone. It may be appreciated that these are merely a few examples of client devices 1002-q, and any electronic device may be implemented as a client device 1002-q (e.g., a smart phone, a tablet computer, a notebook computer, etc.). The embodiments are not limited in this context.

A user may utilize a client device 1002-q to access various web services and web applications provided by a storage center 1020. The storage center 1020 may comprise a cloud computing storage center or a private storage center. Each type of storage center may be similar in terms of hardware, software and network services. Differences between the two may include geography and business entity type. A cloud computing storage center is physically located on premises of a specific business entity (e.g., a vendor) that produces online storage services meant for consumption by another business entity (e.g., a customer). A private storage center is physically located on premises of a specific business entity that both produces and consumes online storage services. A private storage center implementation may be desirable, for example, when a business entity desires to control physical security to equipment used to implement the private storage center.

A cloud computing storage center may utilize various cloud computing techniques to store data for a user of a client device 1002-q. Cloud computing is the use of computing resources (hardware and software) which are available in a remote location and accessible over a network (e.g., the Internet). A user may access cloud-based applications through a web browser or a light-weight desktop or mobile application while business software and user data are stored on servers at a remote location. An example of a cloud computing storage center 1010 may include a Citrix CloudPlatform® made by Citrix Systems, Inc.

The storage system 1020 is an example of a network data storage environment, which includes a plurality of client devices 1002-q coupled to a storage system 1020 via a network 1004. As shown in FIG. 10, the storage system 1020 includes at least one storage server 1022, a switching fabric 1024, and a number of mass storage devices 1028-m, such as nonvolatile mass storage disks, in a mass storage subsystem 1026. Alternatively, some or all of the mass storage devices 1028 can be other types of storage, such as flash memory, optical, solid-state drives (SSDs), tape storage, etc.

The storage server 1022 may be, for example, one of the FAS-xxx family of storage server products available from NetApp®, Inc. The client devices 1002 are connected to the storage server 1022 via the computer network 1004, which can be a packet-switched network, for example, a local area network (LAN) or wide area network (WAN). Further, the storage server 1022 is connected to the mass storage devices 1028 via a switching fabric 1024, which can be a fiber distributed data interface (FDDI) network, for example. It is noted that, within the network data storage environment, any other suitable numbers of storage servers and/or mass storage devices, and/or any other suitable network technologies, may be employed.

The storage server 1022 can make some or all of the storage space on the mass storage devices 1028 available to the client devices 1002 in a conventional manner. For example, each of the mass storage devices 1028 can be implemented as an individual disk, multiple disks (e.g., a RAID group) or any other suitable mass storage device(s). The storage server 1022 can communicate with the client devices 1002 according to well-known protocols, such as the Network File System (NFS) protocol or the Common Internet File System (CIFS) protocol, to make data stored on the mass storage devices 1028 available to users and/or application programs. The storage server 1022 can present or export data stored on the mass storage devices 1028 as volumes to each of the client devices 1002. A “volume” is an abstraction of physical storage, combining one or more physical mass storage devices (e.g., disks) or parts thereof into a single logical storage object (the volume), and which is managed as a single administrative unit, such as a single file system. A “file system” is a structured (e.g., hierarchical) set of stored logical containers of data (e.g., volumes, logical unit numbers (LUNs), directories, files). Note that a “file system” does not have to include or be based on “files” per se as its units of data storage. For instance, a file system may use object or block levels of atomic data units.

Various functions and configuration settings of the storage server 1022 and the mass storage subsystem 1026 can be controlled from a management station 1030 coupled to the network 1004. Among many other operations, data deduplication operations can be initiated from the management station 1030 for logical containers 102 stored in the mass storage devices 1028 of the mass storage subsystem 1026. Alternatively, data deduplication operations can be initiated from the storage server 1022, or from the mass storage subsystem 1026. Embodiments are not limited in this context.

Included herein is a set of flow charts representative of exemplary methodologies for performing novel aspects of the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

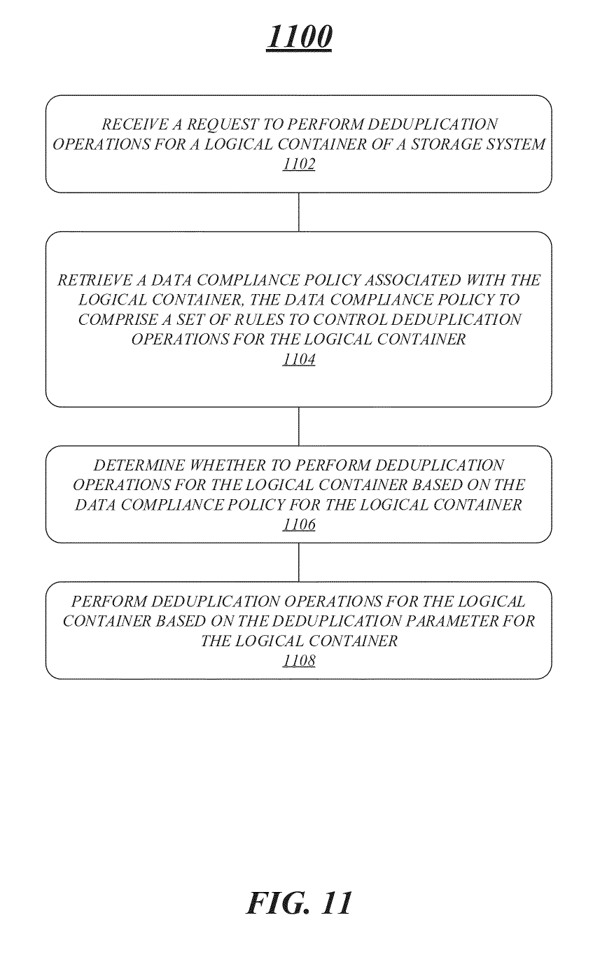

FIG. 11 illustrates one embodiment of a logic flow 1100. The logic flow 1100 may be representative of some or all of the operations executed by one or more embodiments described herein. For instance, the logic flow 110 may represent operations executed by the deduplication application 120 of the apparatus 100.

In the illustrated embodiment shown in FIG. 11, the logic flow 1100 may receive a request to perform deduplication operations for a logical container of a storage system at block 1102. For instance, the deduplication handler component 122-1 of the deduplication application 120 may receive a deduplication request 110 to perform deduplication operations for a logical container 102 of a storage system 1020. The deduplication request 110 may originate from a client device 1002, a storage server 1022, a mass storage subsystem 1026, a management server 1030, or some other device.

The logic flow 1100 may retrieve a data compliance policy associated with the logical container, the data compliance policy to comprise a set of rules to control deduplication operations for the logical container at block 1104. For instance, the policy manager component 122-2 may retrieve a data compliance policy 132 associated with the logical container 102, the data compliance policy 132 to comprise a set of rules to control deduplication operations for the logical container 102. The data compliance policy 132 may be retrieved from the policy database 130, which may comprise a local or remote database of a device executing the deduplication application 120. A policy analyzer module 302 may analyze the data compliance policy 132, and either retrieve or generate a set of deduplication parameters 312 based on the data compliance policy 132.

The logic flow 1100 may determine whether to perform deduplication operations for the logical container based on the data compliance policy for the logical container at block 1106. For instance, the deduplication manager component 122-3 may determine whether to perform deduplication operations for the logical container 102 based on the data compliance policy 132 for the logical container 102. The deduplication manager component 122-3 may analyze the set of deduplication parameters 312 and make control decisions based on the analysis.

The deduplication manager component 122-3 may authorize deduplication operations for the logical container 102 when the set of deduplication parameters 312 indicate a permission granted status for the logical container 102. For instance, this may occur when the logical container 102 has a deduplication authorized parameter to explicitly authorize deduplication operations for the logical container 102, such as in a case of public non-copyrighted content. This may also occur as a default status when the logical container 102 does not have an associated data compliance policy 132 and a liberal storage environment.

The deduplication manager component 122-3 may authorize deduplication operations for the logical container 102 when a set of deduplication parameters indicate a permission conditional status and a condition is met for the logical container 102. A rule may conditionally authorize or deny deduplication operations for a logical container 102. For instance, a rule may be constructed to indicate that deduplication operations are only allowed for the logical container 102 when provided from a particular data source, such as a video distribution provider. In this example, the policy analyzer module 302 may generate and store a deduplication parameter 312-3 with an identifier for the video distribution provider, and a deduplication parameter 312-4 with a conditional operator set to an equal sign. Other examples of a condition may comprise an age for the logical container 102, a data source for the logical container 102, a system time and/or date, and any other suitable conditions.

The deduplication manager component 122-3 may deny deduplication operations for the logical container 102 when a set of deduplication parameters 312 indicate a permission denied status. For instance, this may occur when the logical container 102 has a deduplication denied parameter to explicitly deny deduplication operations for the logical container 102, such as in a case of private copyrighted content. This may also occur as a default status when the logical container 102 does not have an associated data compliance policy 132 and a conservative storage environment.

The logic flow 1100 may perform deduplication operations for the logical container based on the deduplication parameter for the logical container at block 1108. For example, the deduplication manager component 122-3 may perform deduplication operations for the logical container 102 based on the deduplication parameters 312 for the logical container 102. Alternatively, deduplication operations may be performed by another device, such as when the deduplication application 120 is a distributed system implemented by the management server 1030 and the storage server 1022.

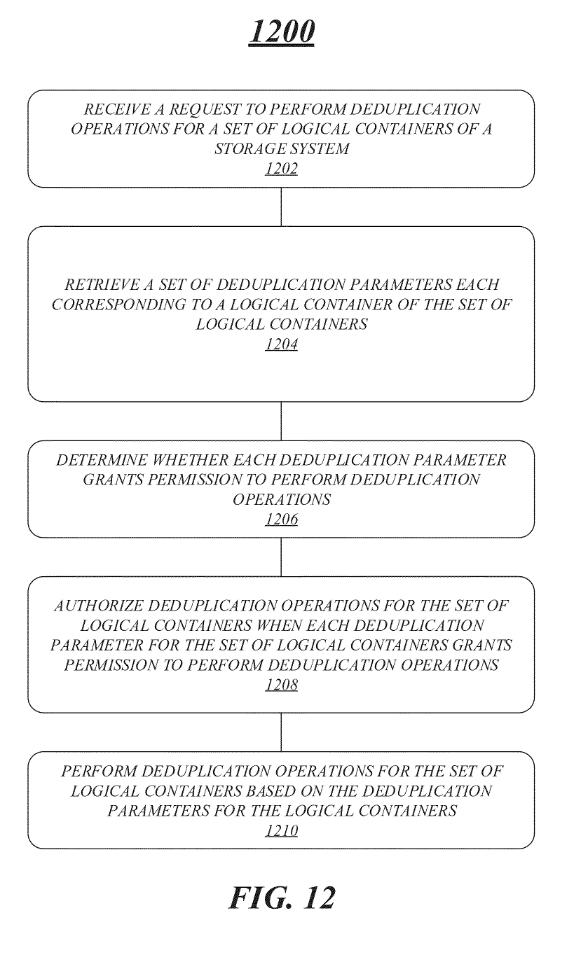

FIG. 12 illustrates one embodiment of a logic flow 1200. The logic flow 1200 may be representative of some or all of the operations executed by one or more embodiments described herein. For instance, the logic flow 1200 may represent an exemplary implementation for the deduplication application 120 when deduplication operations are authorized.

In the illustrated embodiment shown in FIG. 12, the logic flow 1200 may receive a request to perform deduplication operations for a set of logical containers of a storage system at block 1202. For instance, the deduplication handler component 122-1 may receive a deduplication request 110 to perform deduplication operations for a set of logical containers 102-1, 102-2 and 102-3 of the storage system 1020. Although this example indicates 3 logical containers, it may be appreciated that any number of logical containers 102 may be included in the set.

The logic flow 1200 may retrieve a set of deduplication parameters each corresponding to a logical container of the set of logical containers at block 1204. For instance, the policy manager component 122-2 may retrieve a set of deduplication parameters 312-1, 312-2 and 312-3 from container records 304-1, 304-2 and 304-3, respectively, with each corresponding to the logical container 102-1, 102-2 and 102-3, respectively. The container records 304-1, 304-2 and 304-3 may be stored in the policy database 130. Alternatively, the policy manager component 122-2 may retrieve the deduplication parameters 312-1, 312-2 and 312-3 from the policy analyzer module 302 as the data compliance policies 132-1, 132-2 and 132-3 are processed.

The logic flow 1200 may determine whether each deduplication parameter grants permission to perform deduplication operations at block 1206. For instance, the deduplication manager component 122-3 may determine whether each set of deduplication parameters 312-1, 312-2 and 312-3 grant permission to perform deduplication operations for all of the logical containers 102-1, 102-2 and 102-3.

The logic flow 1200 may authorize deduplication operations for the set of logical containers when each deduplication parameter for the set of logical containers grants permission to perform deduplication operations at block 1208. For instance, the deduplication manager component 122-3 may authorize deduplication operations for the set of logical containers 102-1, 102-2 and 102-3 when each set of deduplication parameters 312-1, 312-2 and 312-3 for the set of logical containers 102-1, 102-2 and 102-3 grant permission to perform deduplication operations. Duplicate block detection logic for the deduplication manager component 122-3 may be used to identify duplicate data blocks for the set of logical containers based on a fingerprint for each of the data blocks. Data coalescing logic for the deduplication manager component 122-3 may coalesce the duplicate data blocks for the set of logical containers 102-1, 102-2 and 102-3.

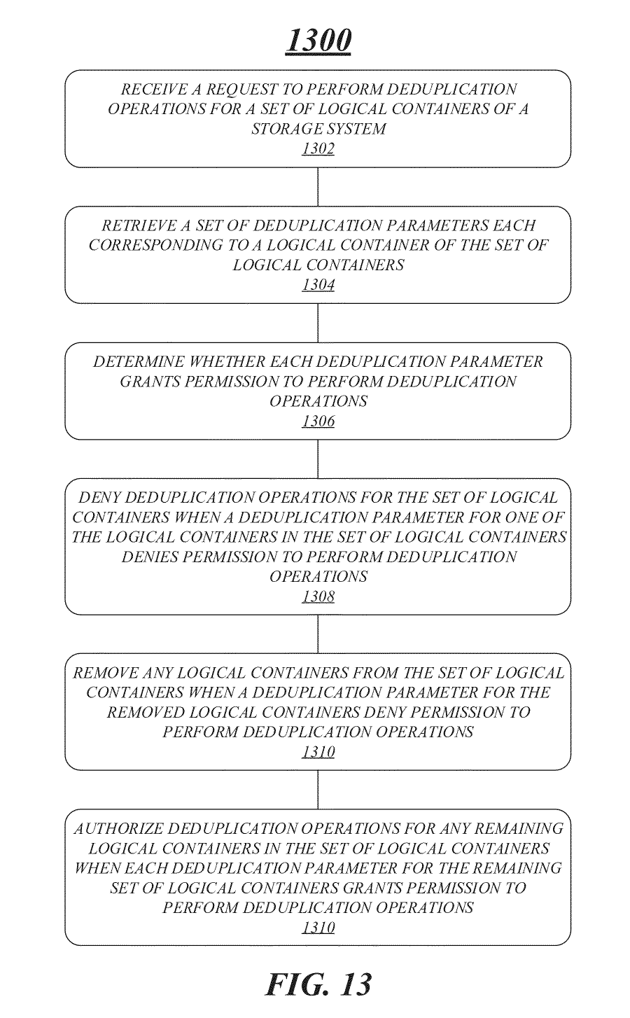

FIG. 13 illustrates one embodiment of a logic flow 1300. The logic flow 1300 may be representative of some or all of the operations executed by one or more embodiments described herein. For instance, the logic flow 1300 may represent an exemplary implementation for the deduplication application 120 when deduplication operations are denied.

In the illustrated embodiment shown in FIG. 13, the logic flow 1300 may receive a request to perform deduplication operations for a set of logical containers of a storage system at block 1302. For instance, the deduplication handler component 122-1 may receive a deduplication request 110 to perform deduplication operations for a set of logical containers 102-1, 102-2 and 102-3 of the storage system 1020. Although this example indicates 3 logical containers, it may be appreciated that any number of logical containers 102 may be included in the set.

The logic flow 1300 may retrieve a set of deduplication parameters each corresponding to a logical container of the set of logical containers at block 1304. For instance, the policy manager component 122-2 may retrieve a set of deduplication parameters 312-1, 312-2 and 312-3 from container records 304-1, 304-2 and 304-3, respectively, with each corresponding to the logical container 102-1, 102-2 and 102-3, respectively. The container records 304-1, 304-2 and 304-3 may be stored in the policy database 130. Alternatively, the policy manager component 122-2 may retrieve the deduplication parameters 312-1, 312-2 and 312-3 from the policy analyzer module 302 as the data compliance policies 132-1, 132-2 and 132-3 are processed.

The logic flow 1300 may determine whether each deduplication parameter grants permission to perform deduplication operations at block 1306. For instance, the deduplication manager component 122-3 may determine whether each set of deduplication parameters 312-1, 312-2 and 312-3 grant permission to perform deduplication operations for all of the logical containers 102-1, 102-2 and 102-3.

The logic flow 1300 may deny deduplication operations for the set of logical containers when a deduplication parameter for one of the logical containers in the set of logical containers denies permission to perform deduplication operations 1308. For instance, assume the deduplication parameters 312-2 for the logical container 102-2 denies permission to perform deduplication operations for the logical container 102-2. The deduplication manager component 122-3 may deny deduplication operations for the entire set of logical containers 102-1, 102-2 and 102-3.

The logic flow 1300 may remove any logical containers from the set of logical containers when a deduplication parameter for the removed logical containers deny permission to perform deduplication operations at block 1310. For instance, the deduplication manager component 122-3 may remove the logical container 102-2 from the set of logical containers 102-1, 102-2 and 102-3 when the deduplication parameter 312-2 for the removed logical container 102-2 denies permission to perform deduplication operations.

The logic flow 1300 may authorize deduplication operations for any remaining logical containers in the set of logical containers when each deduplication parameter for the remaining set of logical containers grants permission to perform deduplication operations. For instance, the deduplication manager component 122-3 may authorize deduplication operations for any remaining logical containers 102-1, 102-3 in the original set of logical containers 102-1, 102-2 and 102-3 when each deduplication parameter for the remaining set of logical containers 102-1, 102-3 grants permission to perform deduplication operations. Deduplication operations may be performed as previously described, where duplicate block detection logic for the deduplication manager component 122-3 may be used to identify duplicate data blocks for the set of logical containers based on a fingerprint for each of the data blocks, and data coalescing logic for the deduplication manager component 122-3 may coalesce the duplicate data blocks for the set of logical containers 102-1, 102-2 and 102-3.

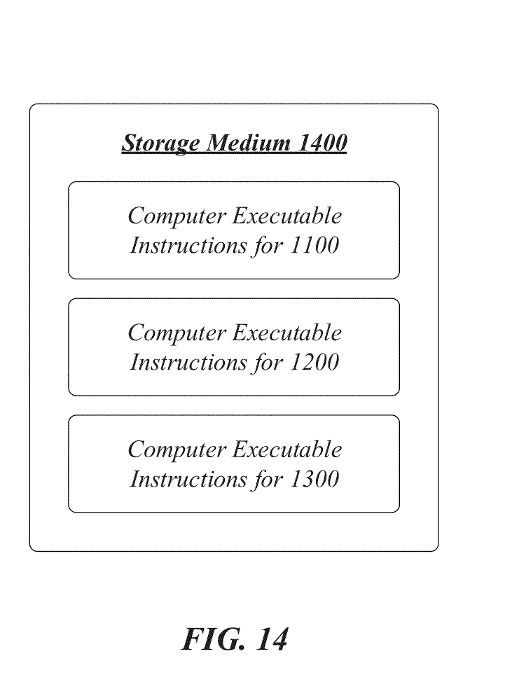

FIG. 14 illustrates an embodiment of a storage medium 1400. The storage medium 1400 may comprise an article of manufacture. In one embodiment, the storage medium 1400 may comprise any non-transitory computer readable medium or machine readable medium, such as an optical, magnetic or semiconductor storage. The storage medium may store various types of computer executable instructions, such as instructions to implement one or more of the logic flows 1100, 1200 and/or 1300. Examples of a computer readable or machine readable storage medium may include any tangible media capable of storing electronic data, including volatile memory or non-volatile memory, removable or non-removable memory, erasable or non-erasable memory, writeable or re-writeable memory, and so forth. Examples of computer executable instructions may include any suitable type of code, such as source code, compiled code, interpreted code, executable code, static code, dynamic code, object-oriented code, visual code, and the like. The embodiments are not limited in this context.

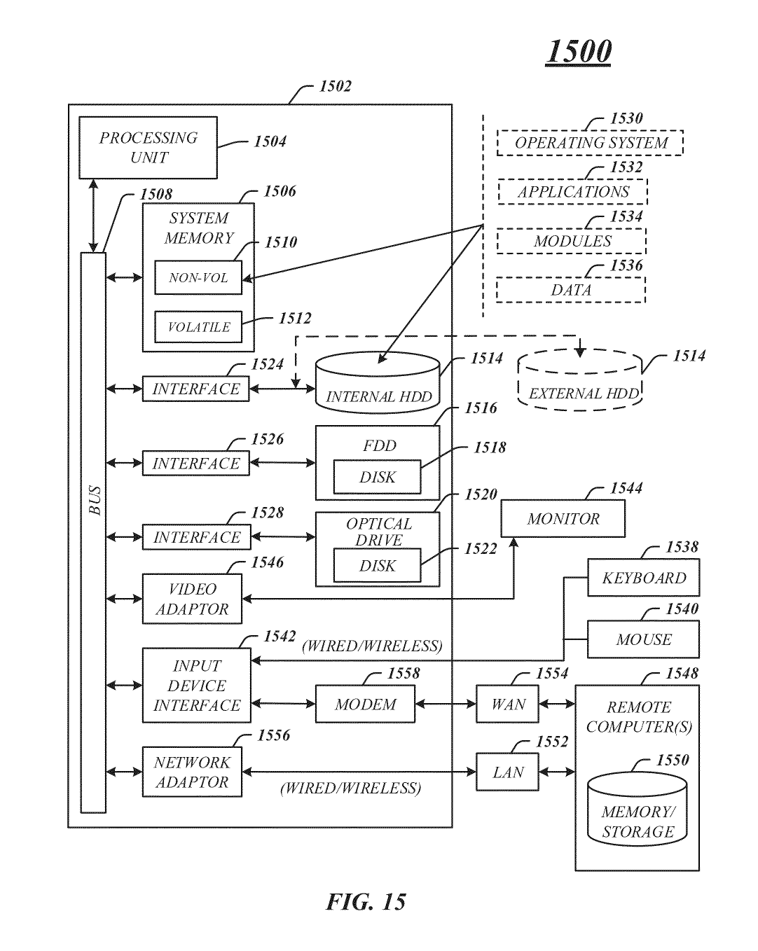

FIG. 15 illustrates an embodiment of an exemplary computing architecture 1500 suitable for implementing various embodiments as previously described. In one embodiment, the computing architecture 1500 may comprise or be implemented as part of an electronic device. Examples of an electronic device may include those described with reference to FIGS. 8-10, among others. The computing architecture 1500 may be used, for example, to implement apparatus 100. The embodiments are not limited in this context.

As used in this application, the terms “system” and “component” and “module” are intended to refer to a computer-related entity, either hardware, a combination of hardware and software, software, or software in execution, examples of which are provided by the exemplary computing architecture 1500. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

The computing architecture 1500 includes various common computing elements, such as one or more processors, multi-core processors, co-processors, memory units, chipsets, controllers, peripherals, interfaces, oscillators, timing devices, video cards, audio cards, multimedia input/output (I/O) components, power supplies, and so forth. The embodiments, however, are not limited to implementation by the computing architecture 1500.

As shown in FIG. 15, the computing architecture 1500 comprises a processing unit 1504, a system memory 1506 and a system bus 1508. The processing unit 1504 can be any of various commercially available processors, including without limitation an AMD® Athlon®, Duron® and Opteron® processors; ARM® application, embedded and secure processors; IBM® and Motorola® DragonBall® and PowerPC® processors; IBM and Sony® Cell processors; Intel® Celeron®, Core (2) Duo®, Itanium®, Pentium®, Xeon®, and XScale® processors; and similar processors. Dual microprocessors, multi-core processors, and other multi-processor architectures may also be employed as the processing unit 1504.

The system bus 1508 provides an interface for system components including, but not limited to, the system memory 1506 to the processing unit 1504. The system bus 1508 can be any of several types of bus structure that may further interconnect to a memory bus (with or without a memory controller), a peripheral bus, and a local bus using any of a variety of commercially available bus architectures. Interface adapters may connect to the system bus 1508 via a slot architecture. Example slot architectures may include without limitation Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and the like.

The system memory 1506 may include various types of computer-readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory, solid state drives (SSD) and any other type of storage media suitable for storing information. In the illustrated embodiment shown in FIG. 15, the system memory 1506 can include non-volatile memory 1510 and/or volatile memory 1512. A basic input/output system (BIOS) can be stored in the non-volatile memory 1510.

The computer 1502 may include various types of computer-readable storage media in the form of one or more lower speed memory units, including an internal (or external) hard disk drive (HDD) 1514, a magnetic floppy disk drive (FDD) 1516 to read from or write to a removable magnetic disk 1518, and an optical disk drive 1520 to read from or write to a removable optical disk 1522 (e.g., a CD-ROM or DVD). The HDD 1514, FDD 1516 and optical disk drive 1520 can be connected to the system bus 1508 by a HDD interface 1524, an FDD interface 1526 and an optical drive interface 1528, respectively. The HDD interface 1524 for external drive implementations can include at least one or both of Universal Serial Bus (USB) and IEEE 1394 interface technologies.

The drives and associated computer-readable media provide volatile and/or nonvolatile storage of data, data structures, computer-executable instructions, and so forth. For example, a number of program modules can be stored in the drives and memory units 1510, 1512, including an operating system 1530, one or more application programs 1532, other program modules 1534, and program data 1536. In one embodiment, the one or more application programs 1532, other program modules 1534, and program data 1536 can include, for example, the various applications and/or components of the apparatus 100.

A user can enter commands and information into the computer 1502 through one or more wire/wireless input devices, for example, a keyboard 1538 and a pointing device, such as a mouse 1540. Other input devices may include microphones, infra-red (IR) remote controls, radio-frequency (RF) remote controls, game pads, stylus pens, card readers, dongles, finger print readers, gloves, graphics tablets, joysticks, keyboards, retina readers, touch screens (e.g., capacitive, resistive, etc.), trackballs, trackpads, sensors, styluses, and the like. These and other input devices are often connected to the processing unit 1504 through an input device interface 1542 that is coupled to the system bus 1508, but can be connected by other interfaces such as a parallel port, IEEE 1394 serial port, a game port, a USB port, an IR interface, and so forth.

A monitor 1544 or other type of display device is also connected to the system bus 1508 via an interface, such as a video adaptor 1546. The monitor 1544 may be internal or external to the computer 1502. In addition to the monitor 1544, a computer typically includes other peripheral output devices, such as speakers, printers, and so forth.

The computer 1502 may operate in a networked environment using logical connections via wire and/or wireless communications to one or more remote computers, such as a remote computer 1548. The remote computer 1548 can be a workstation, a server computer, a router, a personal computer, portable computer, microprocessor-based entertainment appliance, a peer device or other common network node, and typically includes many or all of the elements described relative to the computer 1502, although, for purposes of brevity, only a memory/storage device 1550 is illustrated. The logical connections depicted include wire/wireless connectivity to a local area network (LAN) 1552 and/or larger networks, for example, a wide area network (WAN) 1554. Such LAN and WAN networking environments are commonplace in offices and companies, and facilitate enterprise-wide computer networks, such as intranets, all of which may connect to a global communications network, for example, the Internet.

When used in a LAN networking environment, the computer 1502 is connected to the LAN 1552 through a wire and/or wireless communication network interface or adaptor 1556. The adaptor 1556 can facilitate wire and/or wireless communications to the LAN 1552, which may also include a wireless access point disposed thereon for communicating with the wireless functionality of the adaptor 1556.

When used in a WAN networking environment, the computer 1502 can include a modem 1558, or is connected to a communications server on the WAN 1554, or has other means for establishing communications over the WAN 1554, such as by way of the Internet. The modem 1558, which can be internal or external and a wire and/or wireless device, connects to the system bus 1508 via the input device interface 1542. In a networked environment, program modules depicted relative to the computer 1502, or portions thereof, can be stored in the remote memory/storage device 1550. It will be appreciated that the network connections shown are exemplary and other means of establishing a communications link between the computers can be used.

The computer 1502 is operable to communicate with wire and wireless devices or entities using the IEEE 802 family of standards, such as wireless devices operatively disposed in wireless communication (e.g., IEEE 802.15 over-the-air modulation techniques). This includes at least Wi-Fi (or Wireless Fidelity), WiMax, and Bluetooth™ wireless technologies, among others. Thus, the communication can be a predefined structure as with a conventional network or simply an ad hoc communication between at least two devices. Wi-Fi networks use radio technologies called IEEE 802.15x (a, b, g, n, etc.) to provide secure, reliable, fast wireless connectivity. A Wi-Fi network can be used to connect computers to each other, to the Internet, and to wire networks (which use IEEE 802.3-related media and functions).

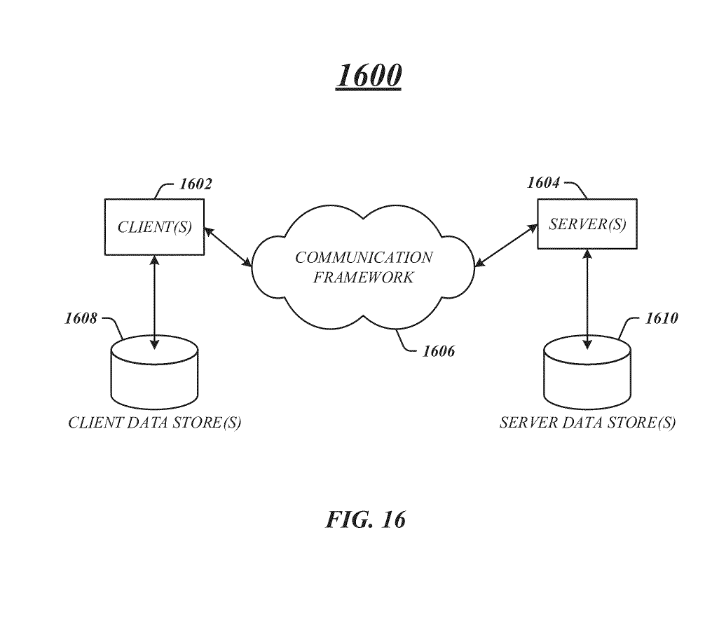

FIG. 16 illustrates a block diagram of an exemplary communications architecture 1600 suitable for implementing various embodiments as previously described. The communications architecture 1600 includes various common communications elements, such as a transmitter, receiver, transceiver, radio, network interface, baseband processor, antenna, amplifiers, filters, power supplies, and so forth. The embodiments, however, are not limited to implementation by the communications architecture 1600.

As shown in FIG. 16, the communications architecture 1600 comprises includes one or more clients 1602 and servers 1604. The clients 1602 may implement the client device 910. The servers 1604 may implement the server device 950. The clients 1602 and the servers 1604 are operatively connected to one or more respective client data stores 1608 and server data stores 1610 that can be employed to store information local to the respective clients 1602 and servers 1604, such as cookies and/or associated contextual information.

The clients 1602 and the servers 1604 may communicate information between each other using a communication framework 1606. The communications framework 1606 may implement any well-known communications techniques and protocols. The communications framework 1606 may be implemented as a packet-switched network (e.g., public networks such as the Internet, private networks such as an enterprise intranet, and so forth), a circuit-switched network (e.g., the public switched telephone network), or a combination of a packet-switched network and a circuit-switched network (with suitable gateways and translators).

The communications framework 1606 may implement various network interfaces arranged to accept, communicate, and connect to a communications network. A network interface may be regarded as a specialized form of an input output interface. Network interfaces may employ connection protocols including without limitation direct connect, Ethernet (e.g., thick, thin, twisted pair 10/100/1000 Base T, and the like), token ring, wireless network interfaces, cellular network interfaces, IEEE 802.11a-x network interfaces, IEEE 802.16 network interfaces, IEEE 802.20 network interfaces, and the like. Further, multiple network interfaces may be used to engage with various communications network types. For example, multiple network interfaces may be employed to allow for the communication over broadcast, multicast, and unicast networks. Should processing requirements dictate a greater amount speed and capacity, distributed network controller architectures may similarly be employed to pool, load balance, and otherwise increase the communicative bandwidth required by clients 1602 and the servers 1604. A communications network may be any one and the combination of wired and/or wireless networks including without limitation a direct interconnection, a secured custom connection, a private network (e.g., an enterprise intranet), a public network (e.g., the Internet), a Personal Area Network (PAN), a Local Area Network (LAN), a Metropolitan Area Network (MAN), an Operating Missions as Nodes on the Internet (OMNI), a Wide Area Network (WAN), a wireless network, a cellular network, and other communications networks.

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Further, some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

It is emphasized that the Abstract of the Disclosure is provided to allow a reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims.

1. An apparatus, comprising:
a processor circuit; and
a deduplication application for execution on the processor circuit to manage deduplication operations for a storage system, the deduplication application to comprise:
a deduplication handler component to receive a deduplication request to perform deduplication operations for a logical container of a storage system;
a policy manager component to retrieve a data compliance policy associated with the logical container, the data compliance policy to comprise a set of rules to control deduplication operations for the logical container; and
a deduplication manager component to determine whether to perform deduplication operations for the logical container based on the data compliance policy for the logical container.

2. The apparatus of claim 1, the deduplication handler component to receive the deduplication request with a logical container identifier to identify the logical container.

3. The apparatus of claim 1, the policy manager component to retrieve the data compliance policy associated with the logical container from a policy database based on the logical container identifier.

4. The apparatus of claim 1, the policy manager component to comprise a policy analyzer module to analyze the data compliance policy, and generate a set of deduplication parameters for the logical container.

5. The apparatus of claim 1, the deduplication manager component to evaluate a set of deduplication parameters for the logical container, and generate a permission granted status to authorize deduplication operations for the logical container.

6. The apparatus of claim 1, the deduplication manager component to evaluate a set of deduplication parameters for the logical container, and generate a permission conditional status to authorize deduplication operations for the logical container when a condition is met.

7. The apparatus of claim 1, the deduplication manager component to evaluate a set of deduplication parameters for the logical container, and generate a permission denied status to deny deduplication operations for the logical container.

8. The apparatus of claim 1, the deduplication manager component to perform deduplication operations for the logical container based on the deduplication parameter for the logical container.

9. The apparatus of claim 1, comprising a memory, transceiver and antenna.

10. An apparatus, comprising:
a processor circuit; and
a deduplication application for execution on the processor circuit to manage deduplication operations for a storage system, the deduplication application to comprise:
a deduplication handler component to receive a request to perform deduplication operations for a set of logical containers of a storage system;
a policy manager component to retrieve a set of deduplication parameters each corresponding to a logical container of the set of logical containers; and
a deduplication manager component to determine whether each deduplication parameter grants permission to perform deduplication operations, and authorize deduplication operations for the set of logical containers when each deduplication parameter for the set of logical containers grants permission to perform deduplication operations.

11. The apparatus of claim 10, the deduplication manager component to perform deduplication operations for the logical containers.

12. The apparatus of claim 10, each of the logical containers from the set of logical containers comprising multiple data blocks, with each data block having an associated fingerprint.

13. The apparatus of claim 10, the deduplication manager component to identify duplicate data blocks for the set of logical containers based on a fingerprint for each of the data blocks.

14. The apparatus of claim 10, the deduplication manager component to coalesce duplicate data blocks for the set of logical containers.

15. The apparatus of claim 10, comprising a storage interface coupled to the processor circuit to access a persistent storage which stores the logical containers for deduplication operations.

16. An apparatus, comprising:
a processor circuit; and
a deduplication application for execution on the processor circuit to manage deduplication operations for a storage system, the deduplication application to comprise:
a deduplication handler component to receive a request to perform deduplication operations for a set of logical containers of a storage system;
a policy manager component to retrieve a set of deduplication parameters each corresponding to a logical container of the set of logical containers; and
a deduplication manager component to determine whether each deduplication parameter grants permission to perform deduplication operations, and deny deduplication operations for the set of logical containers when a deduplication parameter for one of the logical containers in the set of logical containers denies permission to perform deduplication operations.

17. The apparatus of claim 16, the deduplication manager component to remove any logical containers from the set of logical containers when a deduplication parameter for the removed logical containers deny permission to perform deduplication operations, and authorize deduplication operations for any remaining logical containers in the set of logical containers when each deduplication parameter for the remaining set of logical containers grants permission to perform deduplication operations.

18. The apparatus of claim 16, the deduplication manager component to perform deduplication operations for the remaining logical containers.

19. The apparatus of claim 16, comprising a storage interface coupled to the processor circuit to access a persistent storage which stores the logical containers for deduplication operations.

20. A computer-implemented method, comprising:
receiving a request to perform deduplication operations for a logical container of a storage system;
retrieving a data compliance policy associated with the logical container, the data compliance policy to comprise a set of rules to control deduplication operations for the logical container; and
determining whether to perform deduplication operations for the logical container based on the data compliance policy for the logical container.

21. The computer-implemented method of claim 20, comprising:
analyzing the data compliance policy; and
generating a set of deduplication parameters

22. The computer-implemented method of claim 21, comprising authorizing deduplication operations for the logical container when a set of deduplication parameters indicate a permission granted status.

23. The computer-implemented method of claim 21, comprising authorizing deduplication operations for the logical container when a set of deduplication parameters indicate a permission conditional status and a condition is met.

24. The computer-implemented method of claim 21, comprising denying deduplication operations for the logical container when a set of deduplication parameters indicate a permission denied status.

25. The computer-implemented method of claim 21, comprising performing deduplication operations for the logical container based on the deduplication parameter for the logical container.

26. A computer-implemented method, comprising:
receiving a request to perform deduplication operations for a set of logical containers of a storage system;
retrieving a set of deduplication parameters each corresponding to a logical container of the set of logical containers; and
determining whether each deduplication parameter grants permission to perform deduplication operations.

27. The computer-implemented method of claim 26, comprising authorizing deduplication operations for the set of logical containers when each deduplication parameter for the set of logical containers grants permission to perform deduplication operations.

28. The computer-implemented method of claim 26, comprising:
identifying duplicate data blocks for the set of logical containers based on a fingerprint for each of the data blocks; and
coalescing the duplicate data blocks for the set of logical containers.

29. The computer-implemented method of claim 26, comprising denying deduplication operations for the set of logical containers when a deduplication parameter for one of the logical containers in the set of logical containers denies permission to perform deduplication operations.

30. The computer-implemented method of claim 29, comprising:
removing any logical containers from the set of logical containers when a deduplication parameter for the removed logical containers deny permission to perform deduplication operations; and
authorizing deduplication operations for any remaining logical containers in the set of logical containers when each deduplication parameter for the remaining set of logical containers grants permission to perform deduplication operations.

31. At least one computer-readable storage medium comprising instructions that, when executed, cause a system to:
receive a request to perform deduplication operations for a logical container of a storage system;
retrieve a data compliance policy associated with the logical container, the data compliance policy to comprise a set of rules to control deduplication operations for the logical container; and
determine whether to perform deduplication operations for the logical container based on the data compliance policy for the logical container.

32. The computer-readable storage medium of claim 31, comprising instructions that when executed cause the system to analyze the data compliance policy, and generate a set of deduplication parameters

33. The computer-readable storage medium of claim 31, comprising instructions that when executed cause the system to authorize deduplication operations for the logical container when a deduplication parameter is set to a permission granted status.

34. The computer-readable storage medium of claim 31, comprising instructions that when executed cause the system to deny deduplication operations for the logical container when a deduplication parameter is set to a permission denied status.

35. The computer-readable storage medium of claim 31, comprising instructions that when executed cause the system to retrieve a conditional parameter associated with the deduplication parameter for the logical container when the deduplication parameter is set to a permission granted status, the conditional parameter to represent a condition to perform deduplication operations on the logical container.

36. The computer-readable storage medium of claim 31, comprising instructions that when executed cause the system to perform deduplication operations for the logical container based on the deduplication parameter for the logical container.

37. At least one computer-readable storage medium comprising instructions that, when executed, cause a system to:
receive a request to perform deduplication operations for a set of logical containers of a storage system;
retrieve a set of deduplication parameters each corresponding to a logical container of the set of logical containers;
determine whether each deduplication parameter grants permission to perform deduplication operations; and
authorize deduplication operations for the set of logical containers when each deduplication parameter for the set of logical containers grants permission to perform deduplication operations.

38. The computer-readable storage medium of claim 37, comprising instructions that when executed cause the system to identify duplicate data blocks for the set of logical containers based on a fingerprint for each of the data blocks.

39. The computer-readable storage medium of claim 37, comprising instructions that when executed cause the system to coalesce duplicate data blocks for the set of logical containers.

40. The computer-readable storage medium of claim 37, comprising instructions that when executed cause the system to deny deduplication operations for the set of logical containers when a deduplication parameter for one of the logical containers in the set of logical containers denies permission to perform deduplication operations, remove any logical containers from the set of logical containers when a deduplication parameter for the removed logical containers deny permission to perform deduplication operations, and authorize deduplication operations for any remaining logical containers in the set of logical containers when each deduplication parameter for the remaining set of logical containers grants permission to perform deduplication operations.
